(19) United States
(12) Patent Application Publication
(10) Pub. No.: US 2019/0102829 A1
(43) Pub. Date: Apr. 4, 2019

(54) System and Method for Custom Preparation and Combination for Customer Purchase of End of Inventory Items

(71) Applicant: Hadari Oshri, Marina Del Rey, CA (US)

(72) Inventor: Hadari Oshri, Marina Del Rey, CA (US)

(21) Appl. No.: 16/142,508

(22) Filed: Sep. 26, 2018

Related U.S. Application Data
(60) Provisional application No. 62/566,300, filed on Sep. 29, 2017.

(51) Int. Cl. G06Q 30/06; G06F 3/0482

(52) U.S. Cl. CPC G06Q 30/0641; G06Q 30/0621; G06F 3/0482; G06Q 30/0633

(57) ABSTRACT

A computing device user shopper with an enhanced shopping operation experience using a local client shopping application executable on their computing device. The present invention facilitates the matching up of the available products from retailers with the needs and demands of consumers by bundling together separate clothing items available from the retailer to form affordable, curated outfits for presentation to the customer. The solution thus assists customers looking to find affordable outfits via a simplified shopping experience.

### BACKGROUND

### Field of the Invention

The subject matter described herein relates to features for supporting an improved shopping experience on a consumer user's computing device.

### Field of the Invention

Retailers and the customers who use them are connected in that the retailer must adequately and sufficiently provide information about the available products, while the rise of electronic commerce (eCommerce, online commerce, online shopping, or the like) customers face an ever-increasing availability of products. Methods by which the desires of customers can be matched with the inventory of retailers can streamline the process for both.

As style and product preferences change over time, inevitably retailers are left with items that for any number reasons may have failed to sell. As available inventory for any given product is reduced to very low numbers, retailers may reduce the price to quickly move them from available inventory, at a cost to margins.

There is thus a need to match customers with retailers, better aligning the wants of the customers with the available products from the retailers, and moreover in a way that facilitates the clearing out of final inventory items. Such a solution would focus on assisting customers looking to find affordable outfits via a simplified shopping experience. There are currently little to no methods through which this combination of goals is achieved.

### SUMMARY OF THE INVENTION

To minimize the limitations found in the prior art, and to minimize other limitations that will be apparent upon the reading of this specification, the preferred embodiment of the present invention provides a computing device user shopper with an enhanced shopping operation experience using a local client shopping application executable on their computing device. The present invention facilitates the matching up of the available products from retailers with the needs and demands of consumers by bundling together separate clothing items available from the retailer to form affordable, curated outfits for presentation to the customer. The solution thus assists customers looking to find affordable outfits via a simplified shopping experience.

A first objective of the present invention is to facilitate the reduction of final inventory items with various retailers.

A second objective of the present invention is to assemble bundled clothing items in the form of outfits for presentation of a consumer, who may then purchase all items in the bundle simultaneously.

It is a third objective of the present invention to provide customized purchase choices for the customer through data collection via a visual questionnaire, utilizing images as the primary input method.

It is a fourth objective of the present invention to present the user with a simple gesture-based decision process wherein the user swipes right to purchase an item and swipes left to not purchase the item.

These and other advantages and features of the present invention are described with specificity so as to make the present invention understandable to one of ordinary skill in the art.

### BRIEF DESCRIPTION OF THE DRAWINGS

The foregoing aspects and many of the attendant advantages of the invention will become more readily appreciated as the same becomes better understood by reference to the following detailed description, when taken in conjunction with the accompanying drawings, wherein:

FIG. 1A illustrates the user flow throughout the app in a preferred and exemplary embodiment of the invention;

FIG. 1B if the top portion of FIG. 1A shown in more detail;

FIG. 1C if the bottom portion of FIG. 1A shown in more detail;

FIG. 2 illustrates the user authorization sequence in the preferred embodiment of the invention;

FIGS. 3A-F illustrate six steps of registration in the preferred embodiment of the invention;

FIG. 4A is an example of the system utilizing geo and time-based information to link the customer to present the user with access to information about their destination;

FIGS. 4B-4D show an example of two separate retail items combined as a two-piece set;

FIG. 5 is a screenshot illustrating the swiping motion as instructed to the user;

FIGS. 6A-D are a series of screenshots showing the animation and changes to the system as a user swipes left;

FIGS. 7A-C are a series of screenshots showing the animation and changes to the system as a user swipes right;

FIGS. 8A-I are a series of screenshots showing the animation and changes to the system as a user navigates through the check-out process and user flow through the checkout process;

FIGS. 9A-F are a series of screenshots showing the animation and changes to the system as a user enters the menu and selects style categories changes to the system as a user enters the menu and selects size profile;

FIG. 10 is a sales channel diagram; and

FIG. 11 is an ordering and order procurement diagram.

### DETAILED DESCRIPTION OF THE INVENTION

The following discussion addresses a number of embodiments and applications of the present invention. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term “about” means +/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’ and the like are to be construed in an inclusive sense as opposed to an exclusive or exhaustive sense; that is, in the sense of “including, but not limited to”. Words using the singular or plural number also include the plural and singular number, respectively. Additionally, the words “herein”, “wherein”, whereas”, “above”, and “below” and words of similar import, when used in this application, shall refer to this application as a whole and not to any particular portions of the application. Throughout this application, clothing or “outfits” may be replaced in the broader sense with the word “product”.

In a preferred embodiment of the present invention a computing device used by a purchaser provides to the purchaser an on-demand enhanced shopping experience using a local client shopping application executable on said computing device. The present invention facilitates the matching up of the available products from retailers with the needs and demands of consumers by bundling together separate clothing items available from the retailer to form affordable, curated outfits for presentation to the customer, the curated outfits based on the clothing database as it exists in real time, and based on the customer's lifestyle preference, cost sensitivity, and previous purchase history. The solution thus assists customers looking to find affordable outfits via a simplified shopping experience wherein via a simple gesture-based decision process the user may swipe right to purchase an item and swipe left to not purchase the item. As will be detailed, the system facilitates the reduction of final inventory items with various retailers by presenting to the user bundled clothing items in the form of outfits. The various items making up the outfit and thus assembled in a novel way for presentation to a consumer, who may then purchase all items in the bundle simultaneously. Through the collection of customer data via a visual questionnaire utilizing images as the primary input method, the system can present each customer a customized collection of outfits, thereby assisting the customer with outfit preparation and assisting the retailer by reducing final inventory items.

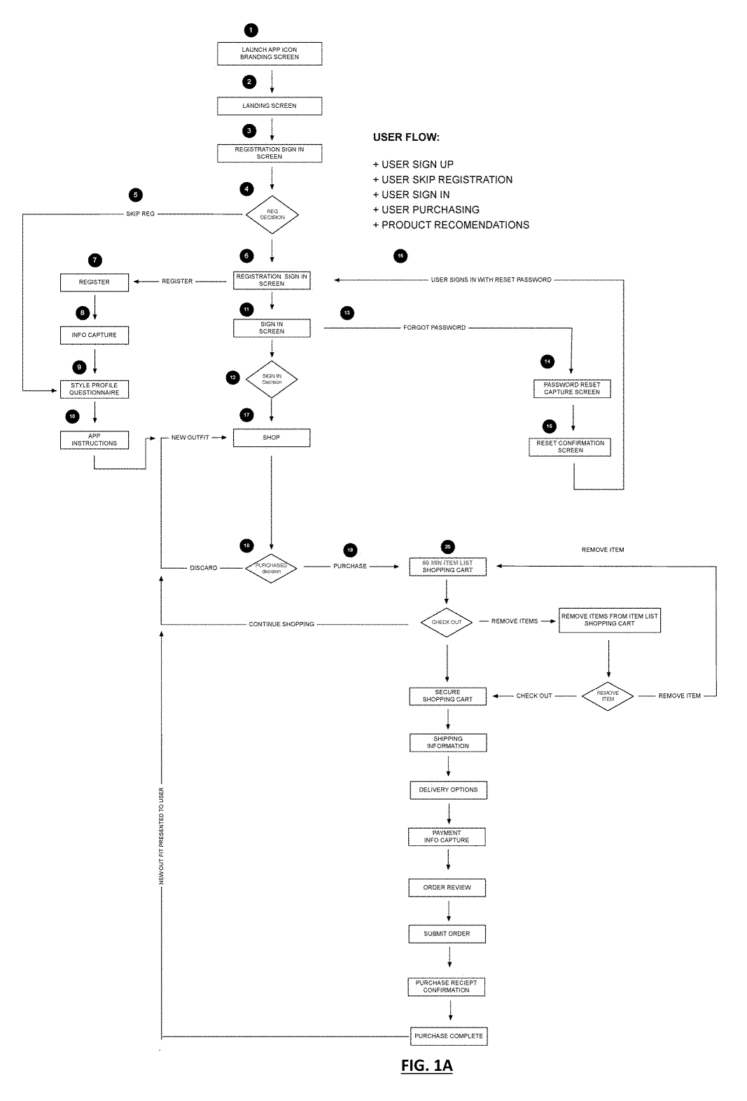

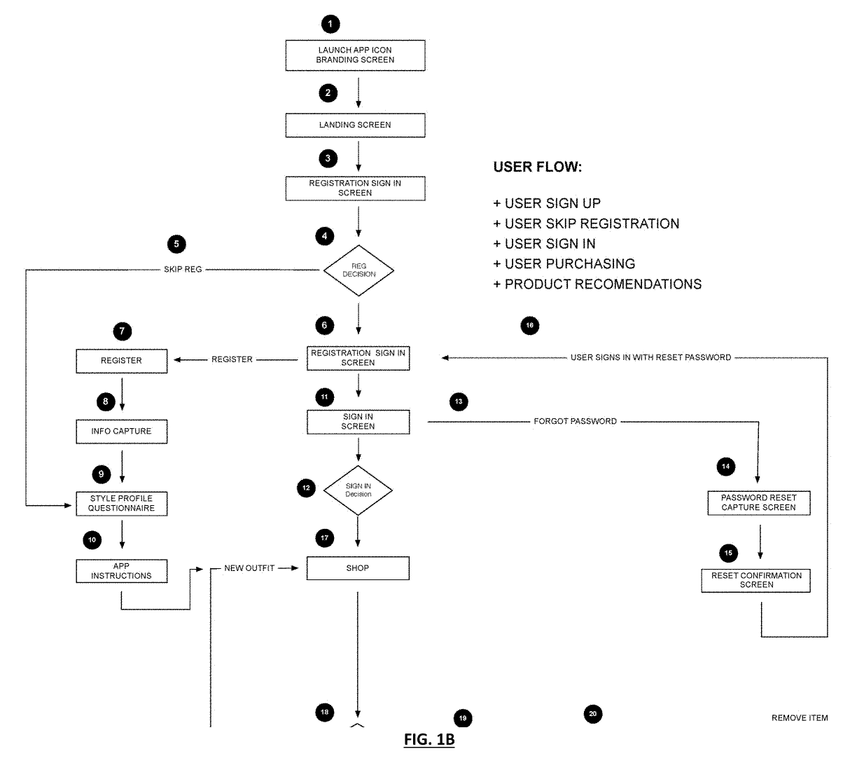

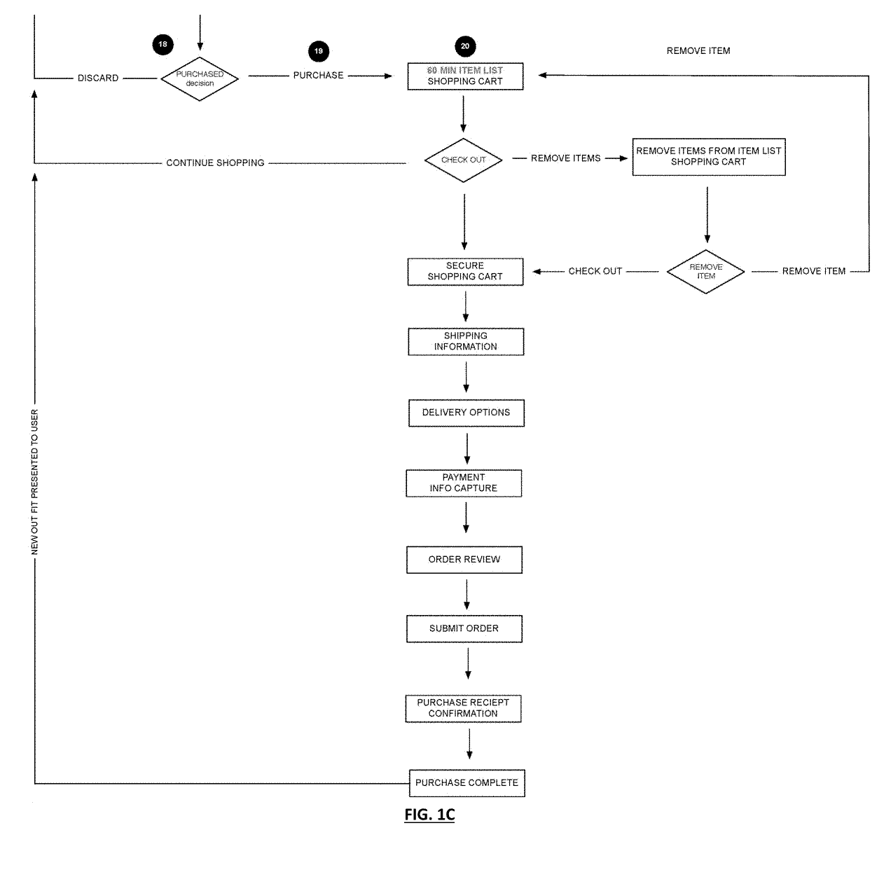

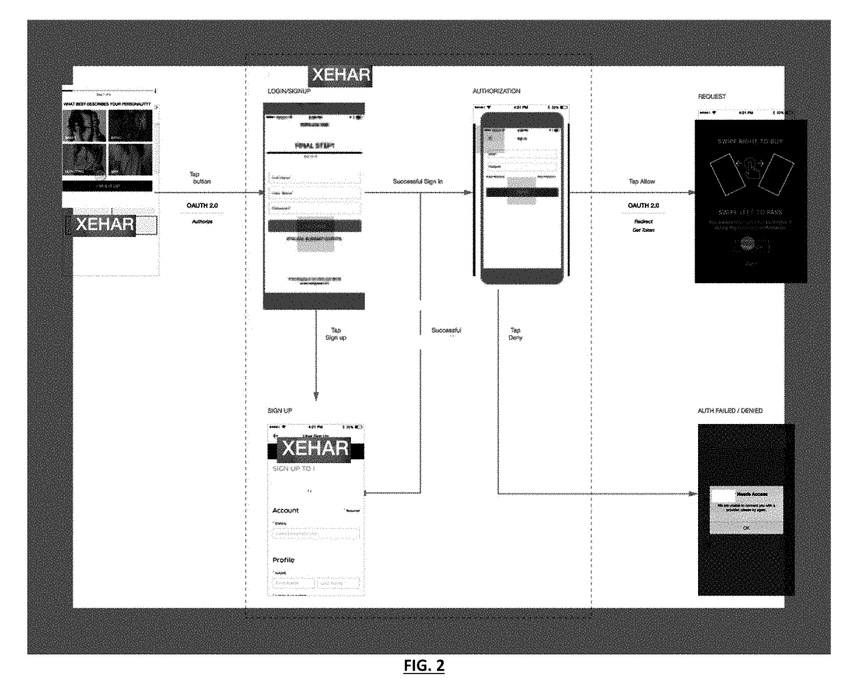

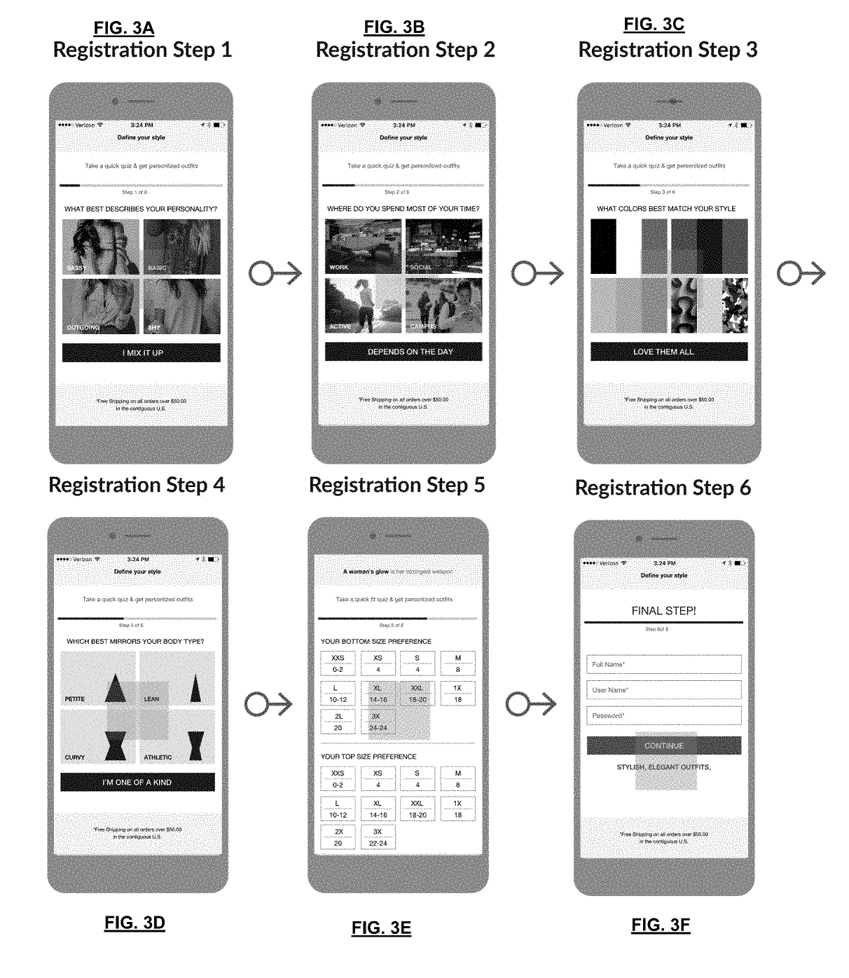

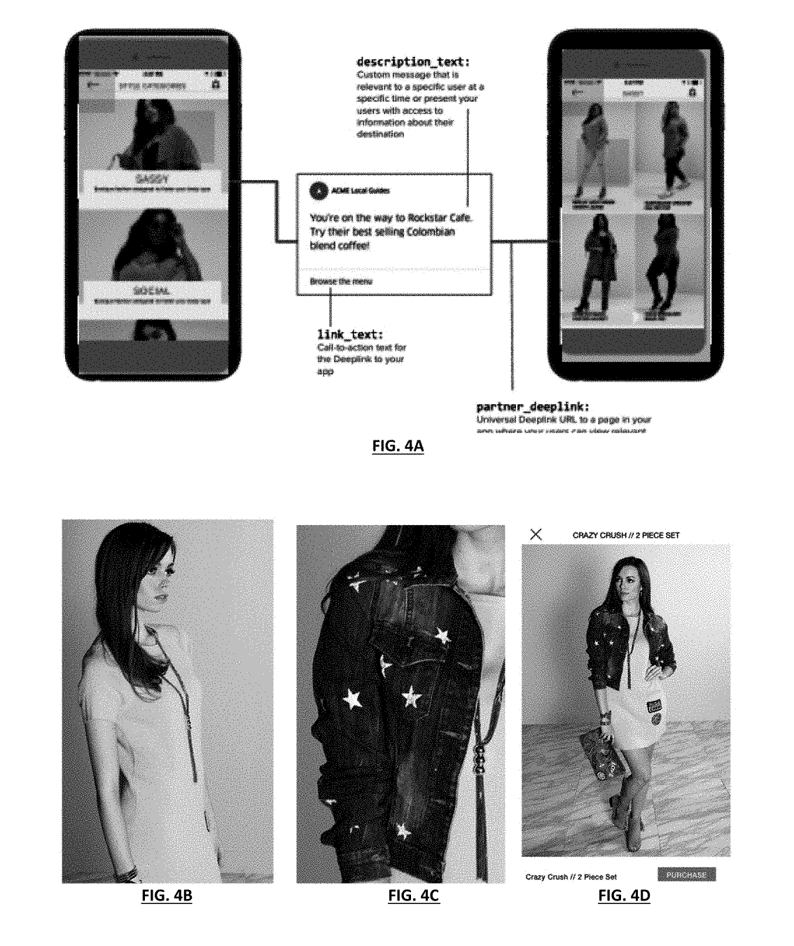

Turning first to FIG. 1A, and illustration of the user flow throughout the app in a preferred and exemplary embodiment of the invention is shown. User authorization is handled in a conventional sense and shown in FIG. 2 and will not be expounded upon in this application. User registration steps are shown in FIG. 3 and as reference number 9 shown in FIG. 1A and FIG. 1B. This section is what will be termed the questionnaire. The purpose of the questionnaire is to assist the system in presenting outfits more likely to be deemed favorable by each customer. The items shown to each customer are thus customized based on the data gathered—that is, the style questionnaire leads to shopping suggestions of targeted outfits to the user based on the user's size, style, and other selection criteria defined by the user questionnaire. Portions of the questionnaire are written (such as height and weight), but portions may also utilize a visual questionnaire wherein various items and outfits are shown to the user, and through the user's swipes (see section Swiping) the system's database is updated with additional information about that user.

Through these questionnaire screens, the system will determine the likes and dislikes of each customer. For instance, for one exemplary customer the system may determine her likes as Shopping, High Fashion, Make-up, Bargains and Fast Fashion, while dislikes may be Shopping online since having a Baby, Shopping in malls/stores since having a baby, Body Shame, Having to change to go out after work, and Items that don't all arrive at the same time.

In addition, lifestyle attributes for the customer may be determined, such as the user's favorite social media, their most used social media for shopping, social activities (such as work dinners, or date nights) as well as other activities, such as hiking, beach-going, nightlife, health and fitness, yoga, etc. For these and other attributes, the system may match each customer's proclivities and wants with appropriate outfits.

The purpose of the questionnaire is to communicates to the database information about which outfits the user would most like to view, and to determine the user classification (Curvy or Standard), to create the user's Measurement Profile, to create the user's Style Profile, to create the user's Material Profile, to determine user Outfit Combinations Classifications. The database may also collect additional information such as the user's style preferences (examples: Trendy, Casual, Business, Active), the user's color preferences (examples: solids, Light, Dark, Pastels), the user's material preferences (examples: Denim, Floral, Earthy, Camouflage), the user's personality traits (examples: Sassy, Basic, Outgoing, Shy), the user's environment preferences (examples: Work, Social, Active, Campus), or the user's garment size preferences (examples: Extra Small, Small, Medium, Large, XL, 2XL, 3XL).

Upon learning the details of the user, the displayed outfit images will reflect the user's Physical Body Type, meaning for instance that curvy women will only see Curvy Curated Outfits and standard women will only see Standard Women Curated Outfits.

Even after the initial questionnaire, the system will continue to learn about the customer. For instance, in some instances the system may work with other data from the user's phone, such as if the user spends a large amount of time at a gym or fitness facility, or a large amount of time in the wilderness. The user may post about such activities to social media, and this information may be gathered as well. Other apps on the user's computing device can collect the sort of data that can be adjust the system's collection of data about the user, in turn adjusting the types of outfits (products) displayed to the user.

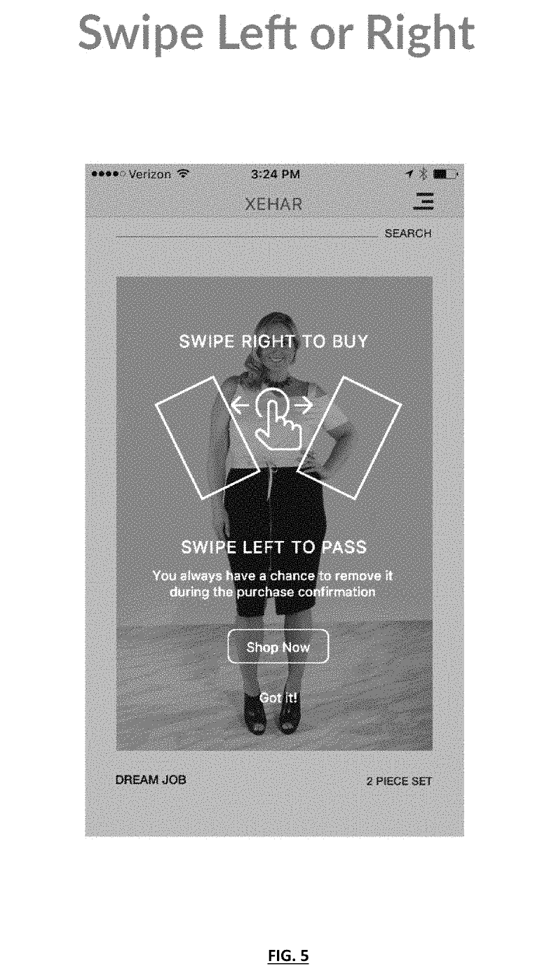

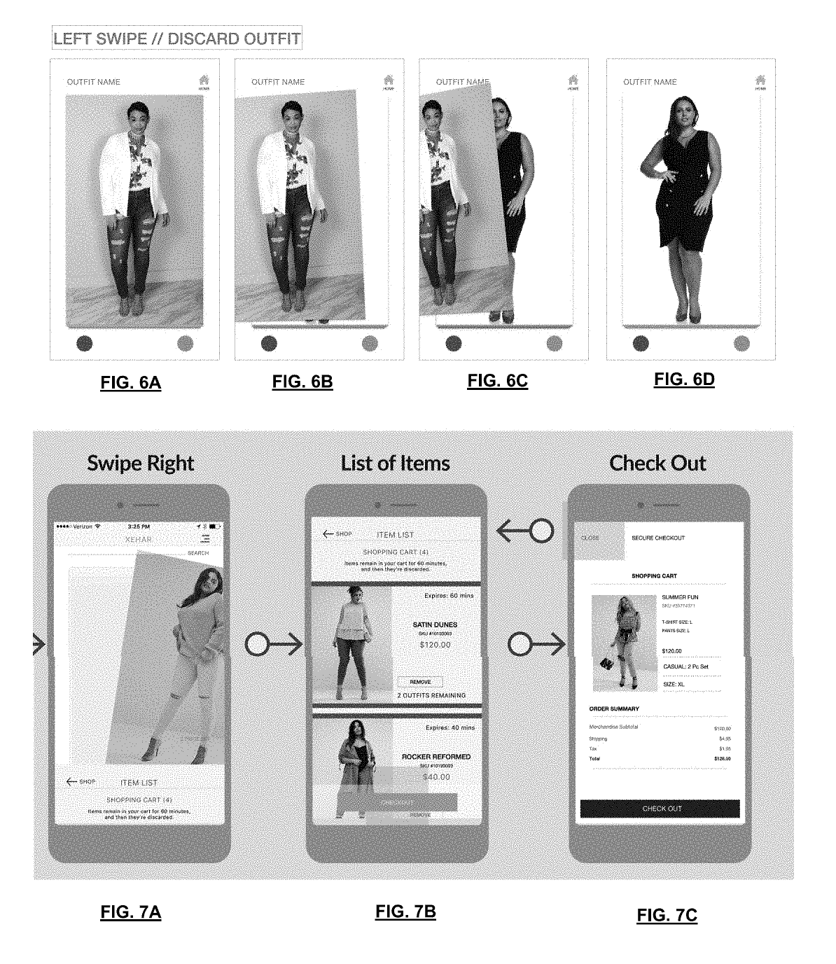

As the user shops, the system employs a form of swiping to show approval or disapproval, as has been conventionally implemented in other apps. A brief tutorial is displayed to the user as shown in FIG. 5. For more info on any given item the user will touch the item, to discard an item the user swipes the item left by making a left-swiping gesture across the face of their mobile computing device (See FIG. 6), revealing in an exemplary embodiment a red overlay to indicate the discarding. After an outfit has been discarded, a new curated outfit is displayed for possible purchase to the user. New curated outfits continue to appear until the user swipes right to initiate a purchase. The opposite gesture, a swipe to the right (FIG. 7), adds the item to a timed shopping cart, while a swipe up will share the item to a social media of the user's choice.

When viewing the items, the user may pinch to zoom as is standard in the art. This can be accomplished through pressing with two fingers close together and opening them or by single tapping on a specific section of the image to view the particular section. A double tap gesture returns the screen to its original size. When zoomed in, the user may move the focused area around by dragging one finger.

A swipe right is received as a gesture to initiate the outfit purchase and buy the item. Purchased Outfit Image displays a Green Overlay as a visual purchase confirmation. FIG. 7 shows an image being swiped to the right. The image then enters the user's shopping cart where a timer is initiated. In this exemplary case, the timer is set to 60 minutes. Other items that have been in the cart for longer show shorter timers, such as the ‘Rocker Reformed” outfit showing a 40-minute timer. Due to the limited (final inventory) nature of the goods available, the item or bundle of items may not be available after it leaves the user's cart. In one instance, the timer is set to 60 minutes, although other amounts of time may be used without departing from the spirit of the invention. All of this, from the predetermined inputs, to the pre-styled/coordinated outfits, to the minimalistic swipe-style “swipe-to-purchase” gesture, to the reduced prices due to no returns and final inventory sales, supports this new paradigm of impulse shopping. During the check-out process, the order cannot be cancelled. As shown in FIG. 1C, the 60-minute window, should the user accept the item then the item is automatically purchased and the user cannot cancel the order in the middle of the check-out sequence.

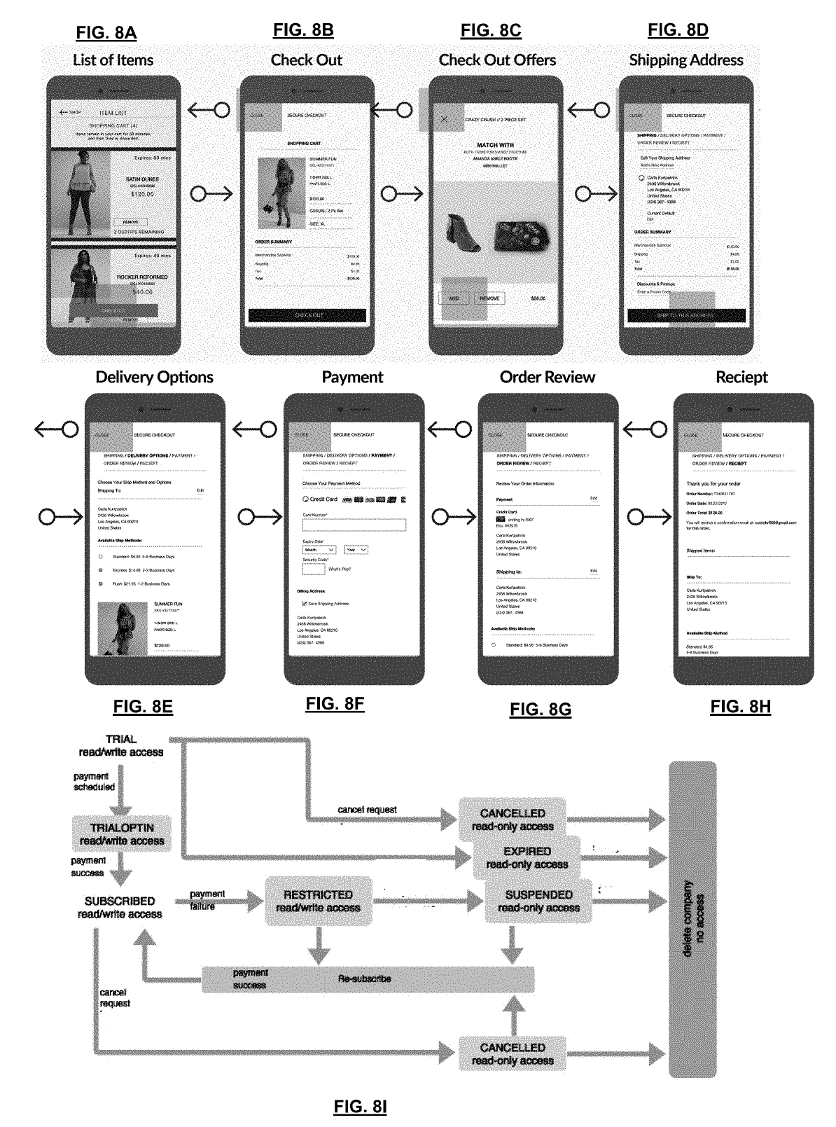

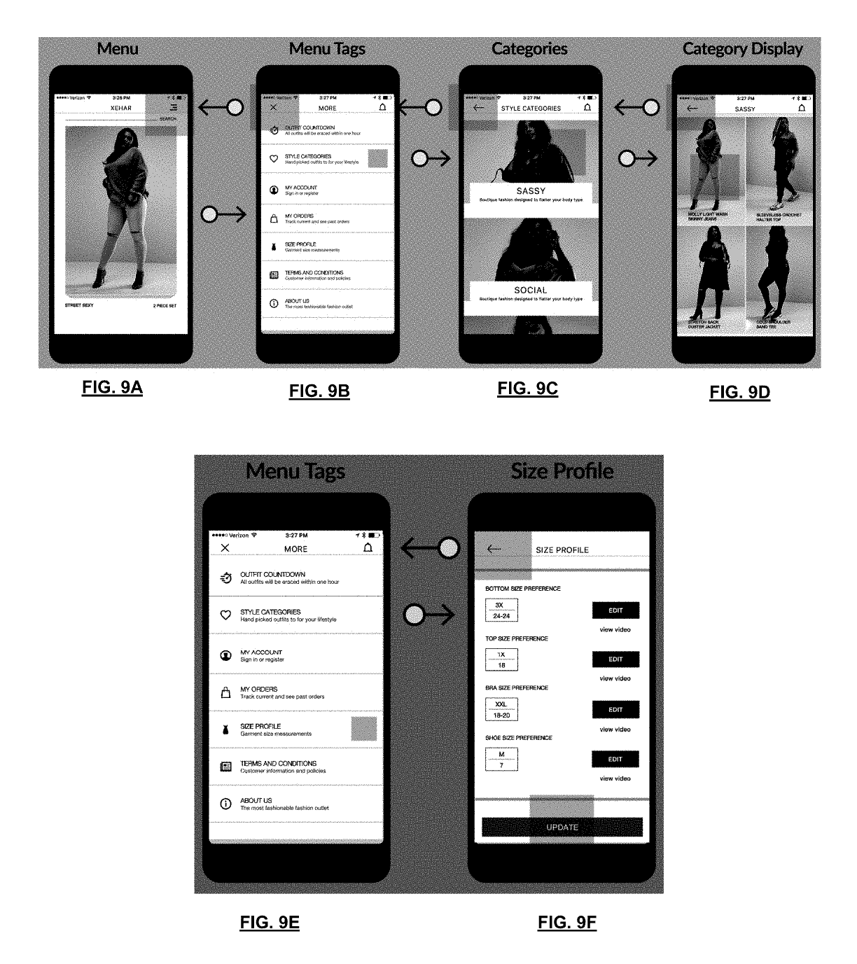

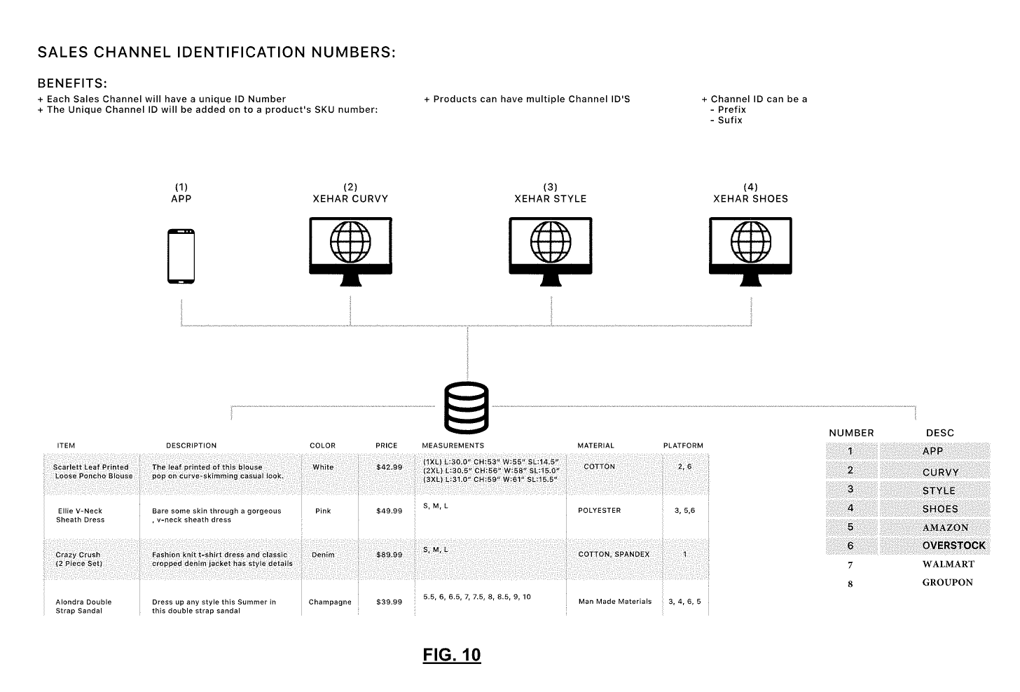

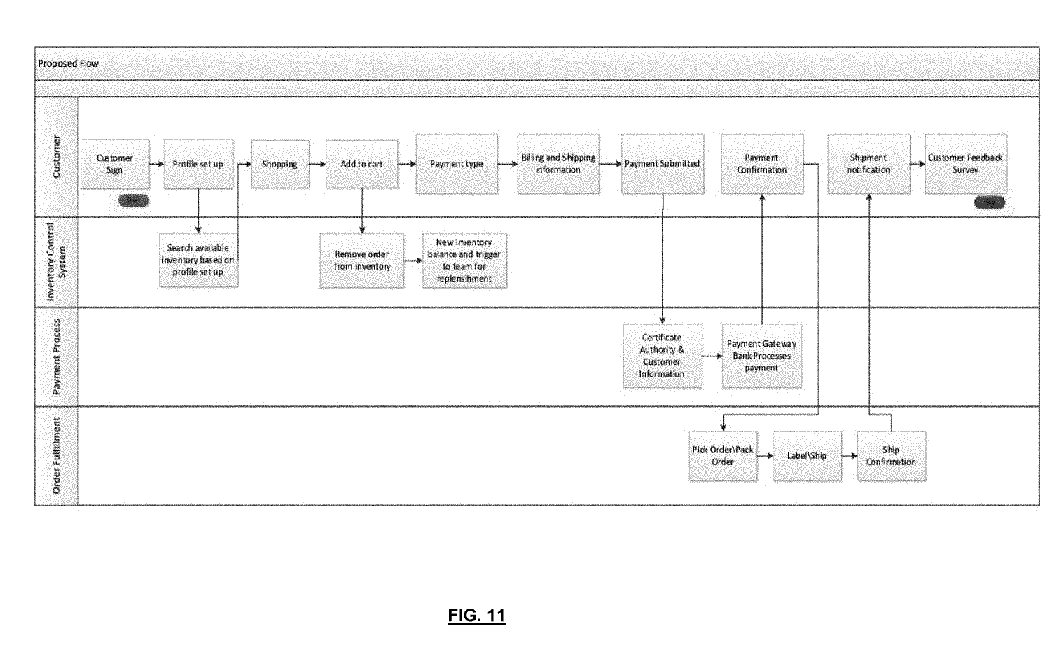

FIG. 8 shows various screenshots of the purchase process. A user's first purchase requires the user to place a credit card on file for future purchases. Credit card information remains in the database for all future purchases, which will be charged to the same credit card on file such that the user does not need to be asked for credit card information again. After Item has been selected, address shipping confirmation appears, which is confirmed by the user. The user has the option to ship/mail purchased outfit to a different address than what's on their profile. After the purchase has been confirmed, recommended separate Items are displayed for purchase. That is, the app displays a complimentary garment and or accessory for the user to purchase. An “ADD” button appears for the user to purchase the displayed product. Product Details and Price accompany the product Image. After recommended separates are displayed, a new Pre-Styled Outfit is displayed for possible purchase. Once this loop has been completed, the user starts the initial Swipe purchase process again. In one instance the is must purchase all outfits individually, while in another instance all outfits may be purchased together at once. Finally, in a yet another alternative embodiment, outfits are purchased and shipped to an address on record with nothing more than a swipe to the right.

The system may also connect shoppers with high profile individuals whose shopping habits are determined to be likely close to those of the user. The shopping actions of the high-profile individual are presented to the user such that the user may rely on the authority of the high-profile individual. Such social influencers, or body influencers, will typically have similar body shapes and/or other characteristics that closely match the user.

In use, the customer never interacts with the app to search for individual or separate items, but uses it instead to find a quick solution for an upcoming event or to build a wardrobe over time. The customer is able to quickly find an outfit without the time, hassle and expense of going from store to store to find matching items. The retailer may draw from a large collection of clothing to assemble outfits for presentation to the user. The system operates in real time as an on-demand system utilizing inventory (preferably final inventory) of a plurality of varying retailers.

In addition, the system tracks time spent looking at an outfit. If over a certain threshold, that outfit is re-targeted later to that user. In one instance, if a customer leaves an outfit on the device screen for more than 7 seconds and does not buy it, the system will note the outfit and if it is available will present it to the user at a later date. In other embodiments, the frequency with which the outfits are repeated to the user may depend on the amount of time the user has left the outfit on the screen. Similarly, when an outfit is left on the screen for a short amount of time, the system may take clues that this is not the sort of outfit that appeals to the customer. Finally, in one embodiment, the system will notify the user the number of other users currently looking at a product. In some instances, this is only done when certain parameters are met, such as a user looking at a screen for four seconds.

The system may also pull inventory data from other retailers. In this way, the selection of products presented to the user can be greatly expanded, and can in real time match up with multiple retailer's final inventory issues.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

1. A computer program product comprising a machine-readable medium storing instructions that, when executed by a mobile device comprising at least one programmable processor, causes the mobile device to perform operations comprising:
displaying, via a screen on the mobile device, a series of product choices bundled together in custom combination for presentation to a user;
receiving, via a user input on the screen, a selection choice and purchase information regarding the custom combination;
providing to the user a limited amount of time during which to cancel the purchase, otherwise, charging the customer for the purchase price; and
delivering a physical item to the customer, the physical item being the custom bundled products.
